(19) United States
(12) Patent Application Publication
(10) Pub. No.: US 2025/0069054 A1
(43) Pub. Date: Feb. 27, 2025

(54) DISTRIBUTED LEDGER BASED SYSTEMS AND METHODS FOR DIGITAL VOUCHER CREATION, MANAGEMENT, AND TRANSACTIONS IN A SUPPLY CHAIN

(71) Applicant: Codehost, Inc., Las Vegas, NV (US)

(72) Inventor: Samer M. ELBIZRI, Las Vegas, NV (US)

(73) Assignee: Codehost, Inc., Las Vegas, NV (US)

(21) Appl. No.: 18/814,369

(22) Filed: Aug. 23, 2024

Related U.S. Application Data
(60) Provisional application No. 63/578,234, filed on Aug. 23, 2023.

(51) Int. Cl. G06Q 20/22; G06F 21/31; G06Q 20/36; G06Q 30/0601

(52) U.S. Cl. CPC G06Q 20/22; G06F 21/31; G06Q 20/36; G06Q 30/0601

(57) ABSTRACT

A system includes an interface, and a management system. The interface includes an encryption component. The management system is configured to generate a digital voucher in response to receiving a request from a user via the interface. The encryption component facilitates an authentication of the user and an authorization of the user prior to submitting the request to the management system. The digital voucher facilitates a supply chain transaction between a seller and a buyer.

### CROSS REFERENCE TO RELATED APPLICATIONS

This U.S. Patent Application claims priority to U.S. Provisional Patent Application No. 63/578,234, titled “DISTRIBUTED LEDGER BASED SYSTEMS AND METHODS FOR DIGITAL VOUCHER CREATION, MANAGEMENT, AND TRANSACTIONS IN A SUPPLY CHAIN,” and filed on Aug. 23, 2023, the disclosure of which is hereby incorporated by reference in its entirety.

### TECHNICAL FIELD

This disclosure relates to distributed ledger based system, and more specifically, to digital voucher management in supply chain transactions.

### BACKGROUND

Unless otherwise indicated herein, the materials described herein are not prior art to the claims in the present application and are not admitted to be prior art by inclusion in this section.

Companies, and suppliers in particular, often find themselves in a challenging position, caught between the need to offer competitive pricing and efficient deliveries, and the realities of high costs and limited liquidity constraining their ability to manage inventory, production, and cash flow. The lack of substantial credit and buying power common among many suppliers further escalates these costs, hinders their ability to plan for future production, and strains resources of the suppliers to risky levels.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a system may include an interface, and a management system. The interface may include an encryption component. The management system may be configured to generate a digital voucher in response to receiving a request from a user via the interface. The encryption component may facilitate an authentication of the user and an authorization of the user prior to submitting the request to the management system. The digital voucher may facilitate a supply chain transaction between a seller and a buyer.

In another embodiment, a method may include obtaining a request to generate a digital voucher from an interface. The request may be obtained from a user that may be authenticated and authorized by an encryption component. The method may also include deploying the digital voucher on a distributed ledger in response to authenticating and authorizing the user. The method may further include implementing a marketplace for transactions associated with the digital voucher. The marketplace may be configured to facilitate a sale of the digital voucher from a seller to a buyer. The method may also include destroying the digital voucher and removing the digital voucher from the distributed ledger in response to a redemption of the digital voucher.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for digital voucher management in a supply chain;

FIG. 2 illustrates an example environment where multiple entities engage the system of FIG. 1;

FIG. 3 illustrates an example environment where multiple entities engage a marketplace associated with the system of FIG. 1;

FIG. 4 illustrates a flowchart of an example method of digital voucher management in a supply chain; and

FIG. 5 illustrates an example computing device.

### DETAILED DESCRIPTION

Many current financing programs, supply chain financing solutions, and/or supply chain technologies have proven inadequate in effectively addressing issues related to offering competitive pricing, efficient deliveries, high costs, limited liquidity, lack of substantial credit, and/or buying power between suppliers and purchasers, including any type of sellers, buyers, payers, and/or payees of any obligation. Many financing programs fall short in providing a comprehensive and efficient solution that suppliers may need to optimize operations and overcome financial challenges faced by the suppliers.

Additionally, these amplified costs may not exist in isolation. For example, the costs may reverberate throughout the supply chain, which may exponentially increase prices and/or risks for enterprise buyers (purchasers) and end customers (customers). Yet, when the costs are strategically managed deeper in the supply chain, the cascading effects of the managed costs can be significantly mitigated, leading to substantial savings for both the customers and the suppliers. The confluence of deep supply chains and elevated procurement and financing costs may result in inflated prices, leaving little room for customer discounts, even for large enterprise customers.

What is needed is a system and method to capture margins by resolving inefficiencies in the financing aspects of the supply chain. Further, what is needed is a digital voucher system to address the existing and persistent challenges described herein, and that offers a pathway to improved supply chain performance.

Aspects of the present disclosure address these and other limitations by utilizing a digital voucher system and method that provides a pathway to improved supply chain performance and profitability. The disclosed system and method is directed to a digital voucher system that may enhance liquidity, sales assurance, and/or environmental, social, and governance (ESG) objectives for supply chain enterprises. Blockchain technology and/or other distributed ledger systems may be used to initiate, record, and/or validate transactions. Alternatively, or additionally, a central entity (or entities) may be used that may be trusted providers using a secure, centralized database, or a cloud-based database. Alternatively, or additionally, individual consumers may use the digital voucher system of the present disclosure in retail transactions. Alternatively, or additionally, the digital voucher system may be used as part of a distribution channel, in a non-profit sector, a governmental sector, and/or a public sector.

The digital voucher system may be used to generate and/or transact one or more digital vouchers that may represent a discount on a future purchase. In general, the digital voucher system may include one or more users performing one or more transactions using the digital vouchers and via computing devices and an associated network.

The digital vouchers may be purchased using the digital voucher system, for a deposit amount, which may be determined as a percentage of the future purchase amount. The purchase of the digital vouchers can provide an influx of cash to the supplier and/or may provide an assurance of future sales to the supplier. The digital vouchers can also be presented with a purchase order from a digital voucher holder or a related entity to obtain a discount on a purchase up to a predetermined purchase amount, which may also vary over time. In some instances, the digital voucher may be sold by a digital voucher issuer to the digital voucher holder. Alternatively, or additionally, the digital voucher holder may obtain the digital voucher using alternative means, as described herein. The digital voucher issuer may use the digital voucher as representative of a commitment to accept a value of the digital voucher upon receipt of the digital voucher from the digital voucher holder.

The digital voucher system may enable a marketplace (e.g., an electronic market) and/or a secondary marketplace for transactions of the digital vouchers. For example, the digital vouchers may be resold at a discount relative to the future purchase amount and/or the deposit amount, which may provide liquidity and/or flexibility for the digital voucher holder. Alternatively, or additionally, the digital voucher system may utilize a distributed ledger technology (e.g., a blockchain ledger) to record and/or verify transactions associated with the digital voucher. The blockchain ledger may provide a secure, immutable, and/or transparent record-keeping of transactions associated with the digital voucher, which may include, but not be limited to, creating the digital voucher, purchasing the digital voucher, redeeming the digital voucher, and/or reselling the digital voucher.

The digital voucher system may be configured to integrate with one or more existing enterprise resource planning (ERP) systems and/or existing transaction management systems (TMSs). The TMS can include data processing systems that support the issuance, purchase, sale, records, authorizations, and controls related to the digital vouchers and systems.

As such, the digital voucher system may enable auto-reconciliation of transactions that include shared records with associated banks and/or suppliers. As such, the digital voucher system may provide users thereof with an opportunity to diversify transactions among multiple tier two and/or tier three suppliers, which may shield the users from potential default risks. At times, the digital voucher may represent a digital representation of an exchange of financial commitments between the digital voucher issuer and the digital voucher holder. The digital voucher may be purchased (e.g., by a digital voucher buyer). Alternatively, or additionally, the digital voucher may be made available in return for a financial obligation and/or a bartered obligation (that may or may not be financial in nature). The digital voucher can be used to secure a purchase from the digital voucher seller for a predetermined value associated with the digital voucher.

The digital voucher may be electronically generated and/or managed, such as by the digital voucher system described herein. For example, the digital voucher may utilize a distributed ledger (such as a blockchain ledger) which may contribute to secure, transparent, and/or immutable transactions. Alternatively, or additionally, the digital voucher may be representative of a deposit amount and/or prepayment toward a future purchase. For example, the digital voucher may include a particular discount (e.g., that may be a percentage, such as 3%) that may be applied to a future purchase from the digital voucher issuer that may be limited to a predetermined number of redemptions (e.g., ten times the deposit amount, or any other amount determined by the digital voucher issuer and/or the digital voucher buyer). The distributed ledger may also be used for the purpose of maintaining independent records of all digital vouchers and associated transactions for purposes of assessing risk, capital flows, and/or optimization, in some instances, through analytics and/or artificial intelligence systems.

In some instances, the digital voucher may have commodity-like characteristics, in that the digital voucher may be resold and/or traded within a secondary market (in contrast to traditional prepayments or deposits). The commodity-like characteristics of the digital vouchers can also facilitate flexibility and/or liquidity to the digital voucher issuer and/or the digital voucher holder, who may be enabled to exchange the digital voucher in the event of changed circumstances for the digital voucher issuer and/or the digital voucher holder.

The digital voucher may also be part of credit or purchasing system, including a credit card, a procurement system, and/or web commerce, among others. In some instances, customers can obtain one or more accounts that may automatically gain access to digital vouchers from sellers, and/or automatically requests digital vouchers from sellers. For example, a buyer may obtain and/or use a credit or payment method, which may include a card, an apparatus, and/or a digital interface to initiate a purchase of an item, a service, or a payment that may automatically request a digital voucher. The automatically requested digital voucher may have a value, a discount, and/or other conditions, any of which may be standardized or customized.

The digital voucher may include a structure such that the digital voucher may not be classified as a security (e.g., such as a stock certificate, a bond, and/or an option). As such, the digital voucher may not be limited to or governed by some regulatory requirements that may otherwise be imposed on a security.

The digital voucher may also include one or more provisions that may direct management of the digital voucher, such as by the digital voucher issuer and/or the digital voucher buyer (and/or the digital voucher holder in the event the digital voucher was transferred). For example, the digital voucher may include provisions related to default associated with the digital voucher, recourse in the event of a default, and/or other provisions associated with risk mitigation between the digital voucher issuer and the digital voucher buyer (or digital voucher holder). Alternatively, or additionally, the digital voucher may be generated in view of ESG principles, which may foster ethical practices within the supply chain associated with the digital voucher.

As will be appreciated by those skilled in the art, physical currency can include currency that may be available in physical form like cash, bills, or coins. The physical currency may be issued and/or regulated by a central entity and may be used for exchange of goods or services. Physical currency may also exist in a digital form, where digital currency can include currency that may be available electronically and can be used for online payments, transfers, and/or in exchange for goods or services. Digital currency can also include, for example, cryptocurrencies secured by cryptography.

A distributed ledger may include a series of records and/or transactions that may be connected via cryptography and stored across multiple computing systems or devices. A digital ledger can take the form of a blockchain where each block contains a cryptographic hash of preceding blocks. Such a design may contribute to making nearly impossible attempts to retroactively change information in a block of the blockchain, unless all subsequent blocks are altered, requiring network collusion. The term “hash” may refer to a condensed fixed-size value derived from larger data sets, such as text strings. Though the hash may typically be smaller than its source data, the hash may be generated in a manner where it may be highly improbable for distinct data to yield identical hash values. Furthermore, deducing the original data may be challenging using solely the hash associated with the original data. This entire system may operate on a network of computing devices, which could be maintaining a blockchain-based ledger.

A digital wallet can also be provided as part of the digital voucher system. The digital wallet can include an electronic device or online service that stores user profile information, payment credentials, and/or bank account information to facilitate online transactions. The digital wallet may streamline the purchase and payment process, and users can load their payment cards onto the digital wallet. The digital wallet can be associated with a person or entity. For example, a person may be an individual, a consumer, or any entity with legal rights and ability to perform actions. Alternatively, or additionally, a digital wallet can be substituted with an account at a bank. Alternatively, or additionally, a regulated entity's custody of currency or assets may be used for the purchase of digital vouchers on the digital voucher system.

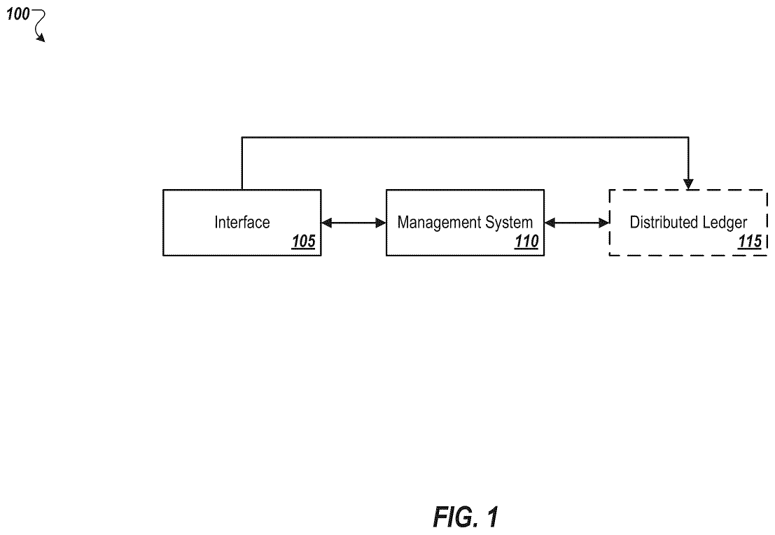

FIG. 1 illustrates a block diagram of an example system 100 for digital voucher management in a supply chain, in accordance with at least one embodiment of the present disclosure. The system 100 may include an interface 105, a management system 110, and a distributed ledger 115. A user may utilize the interface 105 to interact with the management system 110 and/or the distributed ledger 115, wherein the user may generate and/or perform transactions to a digital voucher. The digital voucher and/or the transactions associated therewith may be stored and/or validated using the distributed ledger 115. As illustrated, the distributed ledger 115 may or may not be included in the system 100, where digital vouchers and/or the transactions associated with the digital vouchers as described herein, may be performed with or without the distributed ledger 115.

In some instances, an encryption component in the interface 105 may be operable to perform an authentication operation and/or an authorization operation. Before a user can issue a command in the system 100, the user may authenticate themselves to the system 100. The authentication can be done using usernames and passwords, biometrics, hardware tokens, and/or other authentication methods. Once authenticated, the system 100 may know the identity of the user and can then determine if the user is authorized to issue specific commands. After authentication, the system 100 may check if the authenticated user has the right permissions to execute the command. Operating systems may have permission systems and/or role systems in place. For instance, a regular user might not be able to change system settings, but an administrator would.

In instances in which the system 100 uses the distributed ledger 115, the authentication and/or authorization may include private and public keys and/or signature creation and verification. The fundamental principle behind blockchain wallet authentication is the cryptographic pairing of a public key and a private key. The public key may be an address to which anyone can send funds. The private key may be a secret alphanumeric string known only to the digital wallet owner. The private key may allow the digital wallet owner to access and/or spend the funds stored at the associated public address. When a transaction is initiated from a digital wallet, a digital signature may be created using the private key. Other participants in the network (nodes) may then use the sender's public key to verify the authenticity of the transaction.

Various wallets may be used in conjunction with the system 100, which may include one or more of a software wallet, a hardware wallet, a paper wallet, a web wallet (online wallet), and a multi-signature wallet. The software wallet may include apps or programs installed on a device. The apps or programs may require username/password authentication and may use two-factor authentication (2FA) for added security. The hardware wallet may be a physical device that may store private keys. Authentication may involve pressing a physical button on the device and/or entering a pin. The paper wallet may be a physical document that may include both the private keys and the public keys printed thereon. Authentication may involve manually entering the private key or scanning a QR code. The web wallet may be accessible via a web browser and may require a username and password for authentication and/or may implement 2FA. The multi-signature wallet may require multiple private keys to authorize a transaction, which may add another layer of security. The multi-signature wallet may be used in a business setting where multiple approvals might be utilized for large transactions.

In some instances, the interface 105 may connect to the management system 110 through at least one form of communication channel to read and/or write to the management system 110. Alternatively, or additionally, the management system 110 may connect to the distributed ledger 115 through at least one form of communication channel to read and/or write to the distributed ledger 115. Alternatively, or additionally, the interface 105 may connect to the distributed ledger 115 through at least one form of communication channel to read and/or write to the distributed ledger 115. In these and other embodiments, the communication channels may include direct and/or indirect channels (e.g. networks, internet, middleware, etc.), wired channels (e.g., Ethernet, fiber optics, etc.), wireless communication channels (e.g. Wi-Fi, Bluetooth, 5G, etc.), and/or one or more software and service communication channels (e.g., Application Programming Interfaces (APIs), Remote Procedure Call (RPC), Message Queues like RabbitMQ, Apache Kafka; WebSockets, TCP connection, hypertext transfer protocol (HTTP)/hypertext transfer protocol secure (HTTPS), etc.).

The interface 105 may include one or more underlying interfaces, any of which may contribute to transactions associated with the digital vouchers as described herein. For example, the interface 105 may include one or more of web interfaces, APIs, command line interfaces (CLIs), graphical user interfaces (GUIs), mobile applications, desktop applications, database interfaces, hardware interfaces, software libraries and/or software development kits (SDKs), middleware interfaces, file interfaces, and/or one or more webhooks.

The web interfaces may include any interface provided by a web browser. The web interfaces can also be designed using technologies like hypertext markup language (HTML), cascading style sheets (CSS), JavaScript, and other web development technologies, any of which may create a user-friendly environment.

A user interface (UI) for the system 100 may prioritize simplicity, clarity, and/or ease of use. Some embodiments of the system 100 including a UI may include one or more features and functions as part of the UI. One feature/function may be a dashboard overview that may provide a snapshot of key metrics, like the number of digital vouchers purchased, redeemed, sold, and their respective values. Another feature/function may be purchasing digital vouchers, where sponsors and/or buyers may purchase the digital voucher from the supplier. The digital vouchers may specify details associated with the digital voucher, such as a discount rate, an amount, and/or validity period. Another feature/function may be redeeming digital vouchers, where a supplier may redeem the digital voucher when raising an invoice, or where a buyer may apply the digital voucher to an invoice. Another feature/function may be a secondary market interface, where users of the marketplace may list, buy, and sell digital vouchers. Another feature/function may be a transaction history that may show a detailed log of all transactions related to digital vouchers. Another feature/function may be notifications and/or alerts that may provide reminders for an expiration of a digital voucher, redemption, and/or any other action associated with the digital voucher. Another feature/function may be setting and preferences where a user profile may be managed, preferences associated with notifications may be set, and/or other system settings may be handled.

In some instances, machine-to-machine interfaces may be used in the interface 105, as part of the interface 105, and/or in the communication channels. The machine-to-machine interfaces may be used in digital voucher creation (allow programmatic generation of the digital vouchers), digital voucher redemption (interface to redeem the digital vouchers against an invoice), transaction queries (fetch details of digital voucher-related transactions), marketplace interaction (APIs for listing, buying, selling, and/or querying the secondary market), notification hooks (events that other systems can subscribe to, such as digital voucher redemption, purchase, and/or expiry), price and discount queries (for determining a real-time (or last traded) price of the digital vouchers, applicable discounts, etc.), integration hooks (to seamlessly integrate the system 100 with ERPs, accounting software, procurement systems, etc.), authentication and authorization (secure endpoints to ensure authorized access to data and functions), analytics and reporting (extract data for analysis, reporting, and/or feeding into other systems), and/or blockchain interaction (for interactions with specific endpoints in the blockchain, like querying ledger entries, verifying transactions, etc.).

The APIs may allow various software components to interact with one another. The APIs may also define requests that may be made, methods of making the requests, data formats associated with the requests, and/or other conventions to follow between the software components and/or data transmission between the software components. The APIs may be based on HTTP/representation state transfer (REST), simple object access protocol (SOAP), and/or remote procedure calls (gRPC), etc.

The CLIs may be a text-based interface that may support a user interacting with the system 100. The CLIs may be used by a system administrator and/or a system developer to perform system management tasks.

The GUIs may provide a visual interface with which the user may interact. The GUIs may include graphical icon and/or visual indicators.

The mobile applications may include any interface provided via a mobile device. The mobile applications can also be native to the mobile device. (e.g., built specifically for a particular mobile operating system). Alternatively, or additionally, the mobile application may be designed to be cross-platform (e.g., built to work on multiple operating systems, including multiple mobile operating systems).

The desktop applications may include a software program that may be installed and/or interacted with via a desktop computer or a laptop computer. The desktop application can be performed on a computer, or any electronic device capable of executing computer code. The desktop applications may provide a more robust interface relative to the mobile applications and/or the web interface. Electronic devices can have one or more processors, microprocessors or CPUs that are operable to perform data computation or to comprise devices that work together to perform a function such as data computation. Additionally, memory can be included that permits storage of electronic data. Memory can include, for example, memory chips and disk drives. The use of memory involves the use of a non-transitory computer readable medium that stores instructions which can be executed by a processor to implement a method.

The database interfaces may allow the user to communicate and/or interact with a database. Some examples of database interfaces may include java database connectivity (JDBC) for Java applications and open database connectivity (ODBC) for Windows applications.

The hardware interfaces may include low-level interfaces configured to enable software to interact with hardware included in the system 100. For example, the hardware interfaces may include one or more device drivers.

The software libraries/SDKs may include software tools, definitions, and/or protocols that may enable building of software and/or applications that may be used in the system 100. The software libraries/SDKs may provide predefined functions and/or procedures that may be used by developers creating software or applications for the system 100.

The middleware interfaces may be software layers that may be configured to provide application services that may be in addition to applications available via an operating system. The middleware interfaces may enable disparate applications included in the system 100 with communication channels/interfaces, such that the disparate applications may exchange data with one another.

The file interfaces may enable the system 100 to interact with files that may be located on a disk. For example, a file system API may enable the system 100 to perform file management operations including creating, reading, updating, deleting, and/or other file management operations.

The webhooks may enable augmentation and/or altering of behavior of a web page or web application using custom callbacks. The custom callbacks may be maintained, modified, and/or managed by a user/developer associated with the system 100. Alternatively, or additionally, the custom callbacks may be managed by a third-party user/developer, who may not be affiliated with the system 100.

At least some of the interfaces included in the interface 105 may be configured to communicate with the management system 110 and may be used to generate and/or manage the digital vouchers using the management system 110 and/or the distributed ledger 115. The management system 110 may include one or more computing devices and associated software to process data and/or transaction associated with the digital vouchers.

The management system 110 may obtain instructions to generate a digital voucher, such as via the interface 105. For example, a user (e.g., a digital voucher issuer) may use a networked computing device to submit instructions to the management system 110 to generate the digital voucher. Alternatively, or additionally, the management system 110 may receive instructions to destroy the digital voucher. The instructions associated with generating and/or destroying the digital voucher may include a trusted certificate. For example, a computing device that does not include a trusted certificate may be unable to generate a digital voucher on the management system 110.

Any party accessing the system 100 may be authenticated to confirm their identity, any authorizations, and/or to be in compliance with any laws and regulations governing such party and the system 100 operations. Such authentication may include Know Your Customer (KYC) processes run by an operator of the system 100 or other relevant party, which may include authentication of the business certifications, tax filings, ownership, and/or personnel. The KYC processes can be aided by software tools and/or third party and governmental databases. Authenticated entities may authorize one or more individuals, and, if desired, may integrate a system into the system 100, such as using UIs and/or APIs to connect to the management system 110 and/or the distributed ledger 115. Authorized users may be system authenticated and authorized when interacting with the management system 110.

The system authentication and/or authorization may include a user authenticating themselves to the system 100 before they can issue a command. This can be done using usernames and passwords, biometrics, hardware tokens, and/or other authentication methods. Once authenticated, the system 100 may know the identity of the user and can then determine if the user is authorized to issue specific commands. Alternatively, or additionally, after authentication, the system 100 may check if the user (now authenticated) has the right permissions to execute the command. Operating systems have permission and role systems in place. For instance, a regular user might not be able to change system settings, but an administrator would.

In some instances, the system authentication and/or authorization may include syntax checking as computers expect commands to follow a specific syntax. In instances in which an entered command doesn't match the expected format, the command may be rejected. This may ensure that commands are properly formed and may reduce or prevents errors. In some instances, the system authentication and/or authorization may include input validation where any input from users (including commands) in software applications can be a potential security risk if not validated. The system 100 may check the input against expected patterns, lengths, and/or formats. This can reduce or prevent issues such as SQL injection or buffer overflow attacks. Alternatively, or additionally, the system authentication and/or authorization may include integrity checks. In some systems, especially those that are security-sensitive, commands or data might come with checksums or digital signatures. The system 100 can verify these to ensure the data or command has not been tampered with during transit.

Managing the digital voucher may include the management system 110 transacting on the distributed ledger 115. For example, for any given transaction, the management system 110 may transmit transaction information to the distributed ledger 115. The transactions associated with the digital voucher that may be recorded in the distributed ledger 115 may include, but not be limited to, generation, issuance, transfer, sale, redemption, validation, and/or destruction. The distributed ledger 115 may be centralized or decentralized.

In response to receiving instructions (such as from the interface 105) to redeem, sell, and/or transfer the digital voucher, the management system 110 may communicate an update to the distributed ledger 115. The instructions may be issued from a first user device (e.g., a first user) and may include a second user device or user (e.g., the second user may obtain a transferred digital voucher from the first user). The distributed ledger 115 may store a record of the transaction. Alternatively, or additionally, the users and/or associated user devices may receive notifications of the transaction, which may be generated by the management system 110 and transmitted to the user devices included in the transaction.

The management system 110 may be configured to deploy a smart contract on the distributed ledger 115. The smart contract may include provisions to control an execution associated with a transaction (such as a digital voucher transaction as described herein) that may be performed by recording the terms of the transaction on the distributed ledger 115. Alternatively, or additionally, the smart contract may include signed data which may be validated by a validation protocol using the distributed ledger 115.

Alternatively, or additionally, the management system 110 may use the cloud or cloud-based services in conjunction with or in the alternative to the distributed ledger 115, to facilitate operations associated with the digital voucher, such as the transaction described herein.

The system 100 may be configured to integrate with other computing networks. For example, the system 100 may integrate with a private computing network, a distributed network, and/or the internet. The system 100 may be configured to connect to, run, and/or communicate with the other computing networks.

The system 100 may be configured to use an encryption component, which may include encryption keys, signature validation, and/or authentication systems or devices, as described herein. The encryption component may be included in the interface 105. A key can be any piece of information used in a cryptographic algorithm to transform data into another representation. Thus, a key can include both encryption and decryption algorithms. For example, in instances in which a particular user connects to the management system 110 with a particular computing system, the management system 110 may authenticate the particular user and/or the particular computing system prior to granting access to the particular user to perform any operations that may affect the distributed ledger 115, any components included or stored in the distributed ledger 115 (e.g., the digital voucher), and/or any other repository and/or database associated with the management system 110 and/or with the digital vouchers.

Modifications, additions, or omissions may be made to the system 100 without departing from the scope of the present disclosure. For example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

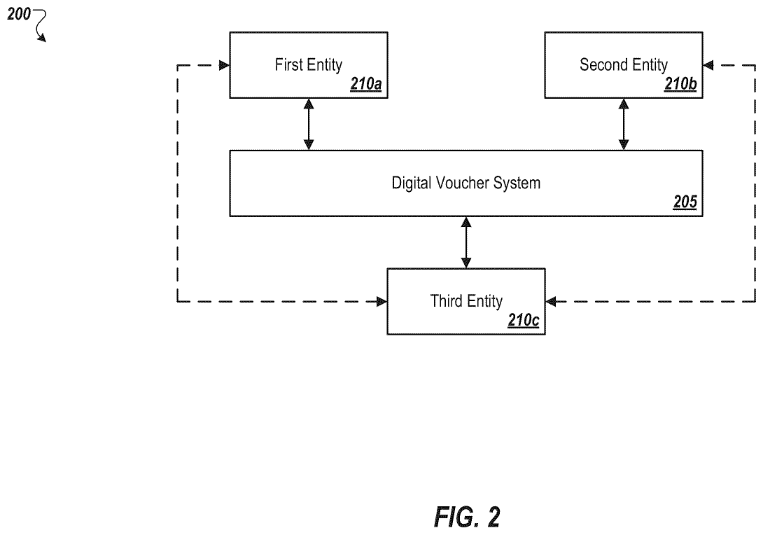

FIG. 2 illustrates an example environment 200 where multiple entities engage a digital voucher system, such as the system 100 of FIG. 1, in accordance with at least one embodiment of the present disclosure. The environment 200 may include a digital voucher system 205 (or system 205), a first entity 210a, a second entity 210b, and a third entity 210c, referred to collectively as the entities 210. The system 205 may be utilized in various operations associated with digital vouchers, including creating, transferring, selling, redeeming, etc. The system 205 may be the same or similar as the system 100 of FIG. 1, including the components thereof and/or the operations that may be performed thereby.

As illustrated, the entities 210 may be connected to the system 205 and may be configured to interface with the system 205 (e.g., the entities 210 may be authenticated by a portion of the system 205). The third entity 210c may be a seller of goods and/or services and may be interested in securing future sales, enhance relationships with customers, and/or obtain liquidity by utilizing the system 205 to generate and/or issue one or more digital vouchers.

In instances in which other entities not the third entity 210c (e.g., the first entity 210a and/or the second entity 210b) are interested in the goods and/or services offered by the third entity 210c, the other entities may be configured to purchase the digital vouchers using the system 205. For example, the first entity 210a may be an investor and/or financing party that may enable the transaction between the second entity 210b and the third entity 210c. In another example, the first entity 210a may be a customer of the second entity 210b and may share the benefits of using the digital voucher with the second entity 210b.

The third entity 210c may issue a digital voucher by using the system 205 and may specify characteristics of the digital voucher. The digital voucher characteristics may include, but not limited to, a requested value for the digital voucher (e.g., a “purchase price”), a future redemption value of the digital voucher (e.g., a “redemption value”), an expiration date associated with the discount value on the future purchase (e.g., a “future purchase discount”), a minimum future purchase amount (e.g., a “future purchase amount”) in order to obtain the future discount, and/or other requirements or data associated with the digital voucher.

In response to the issuing of the digital voucher using the system 205, the first entity 210a and/or the second entity 210b may obtain the digital voucher via a purchase thereof. The system 205 (and/or components of the system 205, such as the management system 110 of FIG. 1) may post the availability of the digital voucher and an entity, such as the first entity 210a, may purchase the digital voucher.

A messaging service may be provided using the system 205 may that facilitate a negotiation of the characteristics of the digital voucher, such as the purchase price, the future purchase discount, and/or other requirements related to the purchase and/or sale of the digital voucher. The negotiation relative to the characteristics of the digital voucher may be performed prior to the issuance of the digital voucher. Alternatively, or additionally, the negotiation relative to the characteristics of the digital voucher may be performed after the issuance of the digital voucher.

A sale of the digital voucher from the third entity 210c to the first entity 210a may include a payment from the first entity 210a to the third entity 210c. The sale of the digital voucher may be performed using one or more of the components included in the system 205. For example, the first entity 210a may purchase a digital voucher from the third entity 210c that may represent a three percent discount on $100,000 future purchase by the second entity 210b from the third entity 210c and the first entity 210a may pay ten percent of such future purchase (e.g., $10,000). In the example, the purchase of the digital voucher may include purchasing a $13,000 conditional digital voucher for $10,000. The third entity 210c may create and issue the digital voucher, which may be a contract between the buyer and seller of the digital voucher (e.g., the first entity 210a and the third entity 210c, respectively).

The digital voucher discount may expire on a prearranged or predetermined date, within a threshold period of time, and/or based on an occurrence of an event. Continuing the example, within the period of the discount (e.g., prior to the expiration of the digital voucher), the second entity 210b may issue a purchase order of $100,000 or more referencing the related digital voucher and/or referencing the purchase order on the digital voucher.

Within the period of digital voucher issuance and the payment date due on invoice(s) related to the purchase order, the second entity 210b may purchase the digital voucher from the first entity 210a for a payment or credit in an amount agreed upon by the first entity 210a and the second entity 210b (e.g., $11,500 for the digital voucher). Under such circumstances, the first entity 210a may obtain a profit on the original purchase of $10,000 and the second entity 210b now holds the digital voucher with a redeemable value greater than what the second entity 210b paid the first entity 210a for the digital voucher, where the digital voucher is redeemable for $13,000.

Continuing the example, the second entity 210b may redeem the digital voucher from the third entity 210c as part or whole payment for invoices due on the purchase order and the second entity 210b may pay the remainder in cash or cash equivalent instruments. The remainder may include the second entity 210b redeeming $13,000 on the digital voucher and paying $87,000 in cash to third entity 210c to cover the remaining balance of the invoice(s) of $100,000, such that the second entity 210b may save $1,500.

One or more aspects of the present disclosure may include a marketplace, where the digital vouchers may be bought and sold, exchanged, or otherwise traded between the entities 210. The marketplace may be a digital platform where the entities 210 (e.g., investors, sponsors, suppliers, and/or customers) may buy, sell, and trade digital vouchers. The marketplace may facilitate interactions, negotiations, and/or transactions between the entities, which may be supported by a robust set of tools and features, including interfaces and connectivity and/or the functionality of the system 205 (and the management system in the system 205). Alternatively, or additionally, a matching engine including a computing system running executable computer code, may connect buyers, sellers, investors and/or other entities in the marketplace to facilitate automation and agreements between buyers and sellers on price, value, discount, and/or other characteristics of a digital voucher or associated transaction.

The marketplace may include tools such as analytics and/or artificial intelligence to perform various tasks, such as personalized digital voucher recommendations, fraud detection, dynamic pricing and offers, predictive analysis, chatbots and customer service, optimized distribution, sentiment analysis, automated redemption process, expiry reminders, supply chain integration, loyalty programs, and/or geo-targeting.

The personalized digital voucher recommendations may include AI predicting the types of digital vouchers a user may be likely to be interested in based on the user's purchasing history, browsing behavior, and/or preferences, and the tools may provide personalized recommendations. Fraud detection may include AI analyzing patterns in digital voucher usage to detect unusual behavior and/or anomalies that might indicate fraudulent activity. For instance, if a single user is redeeming a large number of vouchers in a short time, the AI could flag it for review. The dynamic pricing and offers may include AI suggesting dynamic voucher values based on demand, inventory, and other market variables. For instance, on a day with low foot traffic in a retail store, the system 205 could offer higher discount vouchers to boost sales. The predictive analysis may include AI forecasting the demand for certain vouchers, which may help businesses to plan their marketing and stock strategies accordingly. The chatbots and customer service may include AI-powered chatbots that can assist users in choosing and/or redeeming vouchers. The chatbots can answer questions, provide instructions, and even help with troubleshooting. The optimized distribution may include AI determining the effective channels (e.g., email, SMS, push notifications) to distribute vouchers to maximize redemption rates based on a user segmentation. The sentiment analysis may include AI providing insights into how well the digital vouchers are received based on an analysis of feedback and/or reviews related to digital voucher campaigns on social media and other platforms. Alternatively, or additionally, the AI may suggest improvements to improve the sentiment around the digital vouchers. The automated redemption process may include AI scanning and/or validating physical vouchers using image recognition, which may speed up the redemption process at checkout points. The expiry reminders may include AI predicting which users are likely to forget about their digital vouchers based on past behaviors and send reminders, increasing the chances of redemption of the digital vouchers. The supply chain integration may include AI integrating digital voucher redemptions with inventory management. If a particular product gets a high number of digital voucher redemptions, the AI in the system 205 can alert the supply chain to ensure adequate stock. The loyalty programs may include AI being used to determine which customers should be rewarded with exclusive or special digital vouchers based on their loyalty or spending behavior, ensuring that the most valuable customers are retained. The geo-targeting may include AI analyzing user location data to offer geographically relevant digital vouchers. For example, when a user is near a particular retail store or restaurant, the user might receive a digital voucher offer for a discount, among others.

The marketplace may include and/or utilize distributed ledger technology in the transactions, where the distributed ledger technology may provide transparent, secure, and/or immutable ledger of transactions. Individual digital vouchers and associated transactions may be recorded as a unique block on the distributed ledger technology, which may provide traceability and/or may prevent unauthorized modifications. The marketplace may integrate with existing ERP, customer relationship management (CRM), and/or other financial systems. Alternatively, or additionally, the marketplace may adhere to legal and/or regulatory standards, such as KYC and Anti-Money Laundering (AML) requirements.

A digital voucher supplier (or digital voucher seller) may create and issue digital vouchers within the marketplace. The digital vouchers may represent specific values, discounts, and/or contractual agreements and may be digitally authenticated and stored on the distributed ledger technology.

The entities 210 may list the digital vouchers for sale, bid on available digital vouchers, and/or engage in direct trading of digital vouchers with other entities in the marketplace. The marketplace may support various trading modes, such as auctions, fixed-price sales, and/or barter trades.

The marketplace may include software components that may enable users to interact with one another, buy and sell vouchers, and all the management, analytics, pricings, records and other functions needed for a marketplace system. These components may include one or more of the following components (and descriptions thereof): UI and user experience (UX) dashboard (a main hub for users to see their digital voucher balances, active offers, transaction history, etc.), search and filter (allows users to search for specific digital vouchers or filter by criteria such as discount rate, supplier, validity date, etc.), listing page (for sellers to list their digital vouchers), purchase/trade page (for buyers to purchase or trade digital vouchers), user registration and verification (KYC processes for identity verification where two-factor authentication may be implemented for added security), database (to store user data, digital voucher details, transaction history, etc., securely), blockchain integration (for recording, validating, and ensuring the immutability of digital voucher transactions and/or wallet integration for users to store, send, or receive vouchers), payment gateway (integration with various payment methods (e.g., credit/debit card, bank transfers, digital wallets, etc.) and/or a mechanism to handle cryptocurrencies if accepted), digital voucher verification system (to verify the authenticity and validity of digital vouchers being traded), rating and review system (for users to rate and/or review counterparties based on transaction experiences), reporting and analytics (for users to track their buying/selling patterns, see popular vouchers, etc., and/or for platform administrators to monitor user behavior, marketplace trends, and potential fraudulent activities), communication tools (in-platform messaging for buyers and sellers, and/or notifications (via email, SMS, or in-app) for transaction confirmations, updates, etc.), security measures (encryption protocols to protect data and/or regular audits and penetration testing to identify vulnerabilities), compliance and regulatory component (mechanisms to ensure the system 205 adheres to regional and international laws regarding trading, financial transactions, data protection, etc.), secondary market features (for users who want to resell or trade their vouchers), price matching and recommendation engine (using AI/machine learning (ML) to suggest digital voucher pricing or matching buyers with suitable sellers based on preferences, trading history, etc.), integration APIs (to connect with external systems, services, or tools as required), and/or dispute resolution mechanism (a structured process to handle disputes between buyers and sellers).

The marketplace may utilize smart contracts to automate and/or enforce the terms of the transactions between the entities 210. These self-executing smart contracts may be triggered by predefined conditions and may be recorded on the distributed ledger technology, which may contribute to improved compliance between the entities 210 and/or reducing disputes between the entities 210. The smart contracts may contribute to automating the digital voucher transactions and may contribute to the terms and conditions associated with the digital vouchers may be adhered to, while providing default and/or recourse provisions as needed.

The marketplace may include a visual dashboard which may display available digital vouchers. The visual dashboard may include details associated with the digital vouchers, such as price, discount, issuing entity, expiration date, and/or other pertinent terms associated with the digital voucher. The entities 210 may browse, filter, and/or sort in the visual dashboard to find potential counterparts for transactions.

The digital vouchers may be traded among the entities 210, including investors, sponsors, and/or suppliers. A specialized software component within the marketplace may utilize algorithms to match buyers and sellers based on specified criteria, such as price, volume, discount rate, and/or timing preferences. For example, implementing dynamic pricing with AI in a voucher system to determine optimal voucher values or discounts. Below is a simplified approach using a basic machine learning algorithm for dynamic pricing:
1. Data Collection and Preparation: Collect relevant data such as user purchase history, digital voucher redemption history, time of day/week/year, inventory levels, competitor pricing, external factors including holidays, events, weather conditions, etc.;
2. Feature Engineering: Create features (variables) that might influence digital voucher value. For example, whether the current time is typically a peak shopping time; whether inventory for a particular item is below a threshold; a number of vouchers redeemed for the item over a period of time; etc.;
3. Define Target Variable: This is a variable to be predicted by a model. It could be a voucher value representing the discount percentage;
4. Model Selection: A linear regression model, or more complex problems may benefit from sophisticated models like gradient boosting or neural networks;
5. Training the Model: Using historical data, the model may be trained to predict the digital voucher value based on the features. The data may be split into training and validation sets to evaluate the model's performance;
6. Dynamic Pricing Algorithm: The dynamic pricing algorithm may implement the model selection, various inputs, bounds to limit the voucher pricing, and/or other inputs to obtain the target variable, such as the voucher value and/or the discount percentage;
7. Implementation: When a user interacts with the digital voucher system, gather real-time data to form the features and use a determine digital voucher value function to determine the discount value to offer; and
8. Continuous Learning: As more data becomes available (e.g., how users respond to the dynamically priced digital vouchers), retrain the model to incorporate this new data, refining its predictions over time.

Matching of buyers and sellers may occur through various mechanisms like auctions, bid-ask spreads, and/or direct negotiations. A pricing engine may calculate a current and/or a projected value of the digital vouchers based on various factors including, but not limited to, market demand, underlying discount, issuer's creditworthiness, and/or time until expiration. The pricing engine may be utilized by buyers and/or sellers to inform trading decisions. Entities may engage in direct negotiations through the marketplace platform, fine-tuning the price of the digital vouchers, discount, volume, and/or other terms associated with the digital vouchers.

The entities 210 may utilize APIs and/or other computer software to facilitate automated trading and/or large-scale operations. In such circumstances, the computer software may interface directly with the backend of the marketplace. The direct interface may allow for programmatic discovery, trading, and management of the digital vouchers.

The marketplace may utilize advanced cryptographic techniques to safeguard the privacy and security of user data and transactions included in the marketplace. For example, access controls, authentication protocols, and/or encrypted communication channels may enhance overall security of the marketplace, entities using the marketplace, and/or transactions performed using the marketplace. The marketplace may be configured to adhere to applicable legal and regulatory standards, including KYC and AML requirements.

The entities 210 may have access to real-time analytics, insights, and/or reporting tools, which may provide insights into market trends, performance metrics, and/or risk management. The blockchain-based marketplace may contribute to scalability of the marketplace to support increasing volumes of transactions and/or entities. Alternatively, or additionally, interoperability with other blockchain networks or traditional financial systems may be possible.

Modifications, additions, or omissions may be made to the elements in the environment 200 without departing from the scope of the present disclosure. For example, the designations of different elements in the manner described is meant to help explain concepts described herein and is not limiting. Further, the environment 200 may include any number of other elements or may be implemented within other systems or contexts than those described. For example, any of the components of FIG. 2 may be divided into additional or combined into fewer components.

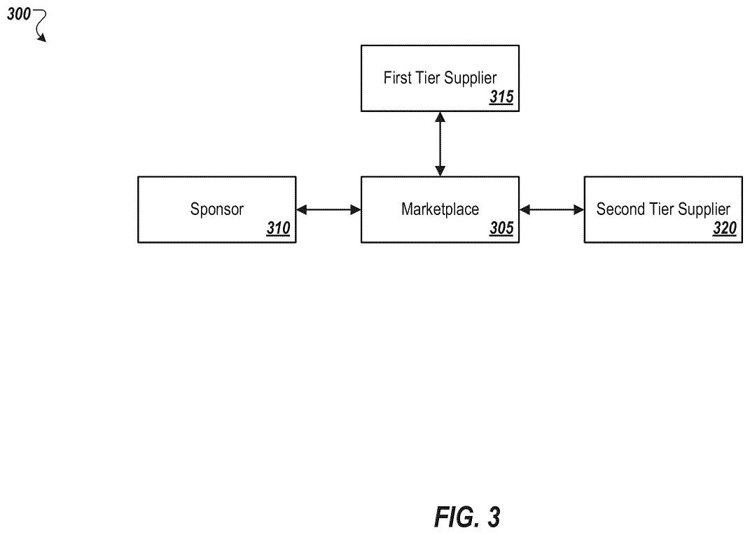

FIG. 3 illustrates an example environment 300 where multiple entities engage a marketplace in a system, such as the system 100 of FIG. 1. The environment may include a marketplace 305, a sponsor 310, a first tier supplier 315, and a second tier supplier 320.

A digital voucher creation may include the second tier supplier 320 creating a digital voucher that may represent a three percent discount on future purchases and the second tier supplier may list the digital voucher on the marketplace 305, which may be a blockchain-based marketplace. The marketplace 305 (including components and/or modules included therein) may authenticate and record the digital voucher on a corresponding distributed ledger, and may assign a unique digital identifier to the digital voucher.

The sponsor 310 may be an enterprise buyer of the digital voucher, may browse the marketplace 305 for various digital vouchers, and may purchase the digital voucher for $10,000. In response, the marketplace 305 may update the distributed ledger and transfer ownership of the digital voucher to the sponsor 310. Alternatively, or additionally, the marketplace 305 may deduct the associated payment for the digital voucher using a smart contract.

In some instances, the sponsor 310 may list the digital voucher on the marketplace 305 for resale to the first tier supplier 315. The first tier supplier 315 may purchase the digital voucher from the sponsor 310 for $11,500, which may result in the first tier supplier 315 realizing a potential savings of $1,500 on future purchases. The sponsor 310 and the first tier supplier 315 may have other financial arrangements, including netting and offsetting of obligations, shared use of the digital voucher, and/or other financial arrangements. The marketplace 305 may facilitate the resale of the digital voucher, update the ownership thereof on the distributed ledger, and/or execute the smart contract for payment processing.

The first tier supplier 315 may place a purchase order with the second tier supplier 320 for $100,000 and make reference the digital voucher. In response, the marketplace 305 may validate the digital voucher using the distributed ledger (e.g., the blockchain) and may apply the associated discount included in the digital voucher. The first tier supplier 315 may pay the remaining balance (e.g., $87,000) directly to the second tier supplier 320.

Modifications, additions, or omissions may be made to the elements in the environment 300 without departing from the scope of the present disclosure. For example, the designations of different elements in the manner described is meant to help explain concepts described herein and is not limiting. Further, the environment 300 may include any number of other elements or may be implemented within other systems or contexts than those described. For example, any of the components of FIG. 3 may be divided into additional or combined into fewer components.

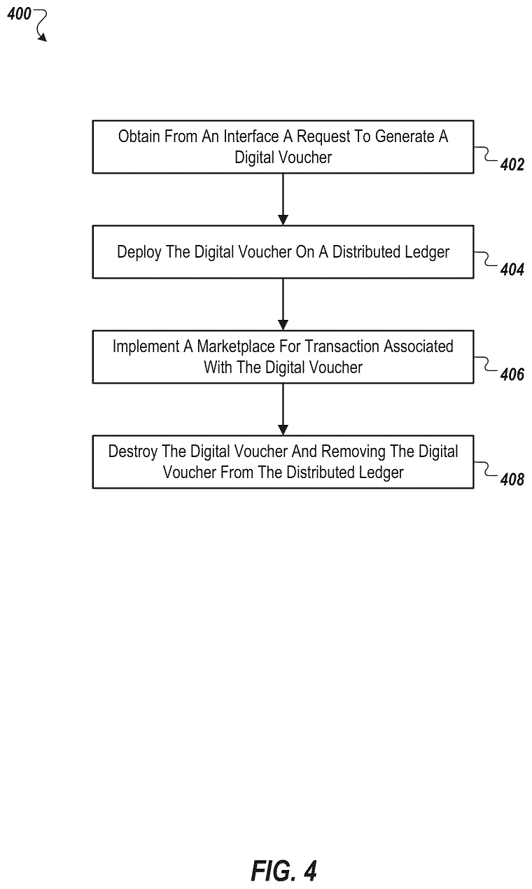

FIG. 4 illustrates a flowchart of an example method 400 of digital voucher management in a supply chain, in accordance with at least one embodiment of the present disclosure. The method 400 may be performed by processing logic that may include hardware (circuitry, dedicated logic, etc.), software (such as is run on a general purpose computer system or a dedicated machine), or a combination of both, which processing logic may be included in any computer system or device such as the system 100 or the management system 110 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 402, a request to generate a digital voucher may be obtained from an interface. The request may be obtained from a user that may be authenticated and authorized by an encryption component. The digital voucher may include one or more characteristics including a purchase price, a redemption value, an expiration date, a future purchase discount, and/or a future purchase amount. The authentication of the user may confirm an identity of the user and the authorization of the user may confirm the user has permissions to submit the request.

At block 404, the digital voucher may be deployed on a distributed ledger in response to authenticating and authorizing the user. In some instances, the digital voucher may be stored in a digital wallet and the digital wallet may be used for transactions in the marketplace.

At block 406, a marketplace for transactions associated with the digital voucher may be implemented. The marketplace may be configured to facilitate a sale of the digital voucher from a supply entity to a purchase entity. In some instances, the purchase entity may obtain the digital voucher by a transaction with the supply entity via the marketplace. Alternatively, or additionally, the purchase entity may obtain the digital voucher by a transaction with a third entity via the marketplace.

At block 408, the digital voucher may be destroyed and the digital voucher may be removed from the distributed ledger in response to a redemption of the digital voucher.

Additional systems and methods may be contemplated relative to those described herein, and are further detailed by the following descriptions. A computer implemented system and method may include receiving, by a central computer network, a trusted certificate that may grant permission to the central computer network to generate or destroy a digital vouchers. The central computer network may be associated with a central bank. A request for digital currency may be received by the central computer network from a redeeming entity device associated with a bank granted permission by the transaction processing network to validate transactions. The request may include a serial number and/or a denomination of a physical currency. The digital voucher may be generated by the central computer network using the trusted certificate. The generating of the digital voucher may include recording the digital voucher on a blockchain to a record that includes the characteristics of the digital voucher's redemption and related transactions and parties. In some instances, a notification of the generation of the digital currency may be transmitted by the central computer network to the redeeming entity device. Alternatively, or additionally, the physical currency may be removed by the central computer network from circulation in a fiat currency system. The removal of the physical currency from circulation may include physically destroying the physical currency.

Some systems and methods for creating digital vouchers for future discounted purchases in a supply chain may include generating a digital voucher, where the digital voucher may represent a discount on a future purchase amount. Alternatively, or additionally, a deposit may be received for the digital voucher, where the deposit may represent a percentage of the future purchase amount. In some instances, the digital voucher holder may be enabled to present the digital voucher with a purchase order to receive a discount on the purchase. In some instances, the digital voucher may be resold on a secondary market. Alternatively, or additionally, the digital voucher may be recorded on a blockchain ledger, which may provide full transparency and traceability of the digital voucher.

Some systems for managing digital vouchers in a supply chain may include a digital voucher generation module for creating digital vouchers, where the digital vouchers may represent a discount on a future purchase amount. The systems for managing digital vouchers may also include a deposit module for receiving deposits for the digital vouchers. Alternatively, or additionally, the systems for managing digital vouchers may further include a transaction module for processing digital voucher redemptions and sales in a secondary market. The systems for managing digital vouchers may also include a blockchain module for recording and tracking transactions associated with the digital vouchers. The blockchain module may provide immutable records of all discounts, deposits, and/or settlements, along with full traceability and/or privacy. The deposit, discount, voucher creation, and voucher transactions may all be recorded and verified on a distributed ledger, which may provide a secure and/or immutable history of all operations. In some instances, the details of each digital voucher transaction may be hashed to generate a unique transaction identifier. The unique transaction identifier may be stored on the blockchain to ensure the transaction's immutability, privacy, and/or traceability. In some instances, the blockchain ledger may contribute to a secure and/or tamper-proof record-keeping of each digital voucher transaction, which may include the creation, purchase, redemption, and/or resale of the digital vouchers.

In some instances, a blockchain-based marketplace may be used for trading digital vouchers. The blockchain-based marketplace may include a digital platform that may facilitate buying, selling, and/or trading of digital vouchers. The blockchain-based marketplace may also include a blockchain ledger that may record each digital voucher and/or transactions associated with the digital vouchers. The blockchain-based marketplace may further include means for creating and issuing digital vouchers that may be digitally authenticated. The blockchain-based marketplace may also include trading mechanisms that may be used for listing, bidding, and/or direct trading of the digital vouchers. The blockchain-based marketplace may further include smart contracts that may automate and/or enforcing transaction terms associated with the digital vouchers. The blockchain-based marketplace may further include security and privacy features that may utilize cryptographic techniques, access controls, authentication protocols, and/or encrypted communication channels. The blockchain-based marketplace may also integrate with existing ERP, CRM, and/or financial systems. In some instances, the trading mechanisms may include auction modes, fixed-price sales, and barter trades. Alternatively, or additionally, the smart contracts may be self-executing and/or may be triggered by predefined conditions recorded on the blockchain ledger.

In some instances, a method for trading digital vouchers in a blockchain-based marketplace may include creating and issuing a digital voucher that includes digital authentication. The method may also include listing the digital voucher for sale within a digital platform. The method may further include engaging in a transaction via bidding, direct trade, and/or other trading modes in the marketplace. The method may also include recording the transaction on a blockchain ledger. The method may further include executing smart contracts to enforce transaction terms associated with the transaction. The method may also include generating real-time analytics, insights, and/or reporting tools for users within the digital platform.

In these and other embodiments, the systems and methods described herein may utilize AI. The AI may contribute to achieving one or more of enhancing user experiences, with customization, combating fraud, optimizing voucher purchase pricing, and/or adding automations, such as auto-redemption of the digital vouchers.

Modifications, additions, or omissions may be made to the method 400 without departing from the scope of the present disclosure. For example, in some instances, the sale of the digital voucher may be transacted from the purchase entity to a third party in the marketplace. Alternatively, or additionally, a smart contract may be automatically deployed on the distributed ledger in response to a predefined condition being satisfied. The smart contract may be configured to execute operations associated with the digital voucher.

In another example, the designations of different elements in the manner described is meant to help explain concepts described herein and is not limiting. Further, the method 400 may include any number of other elements or may be implemented within other systems or contexts than those described.

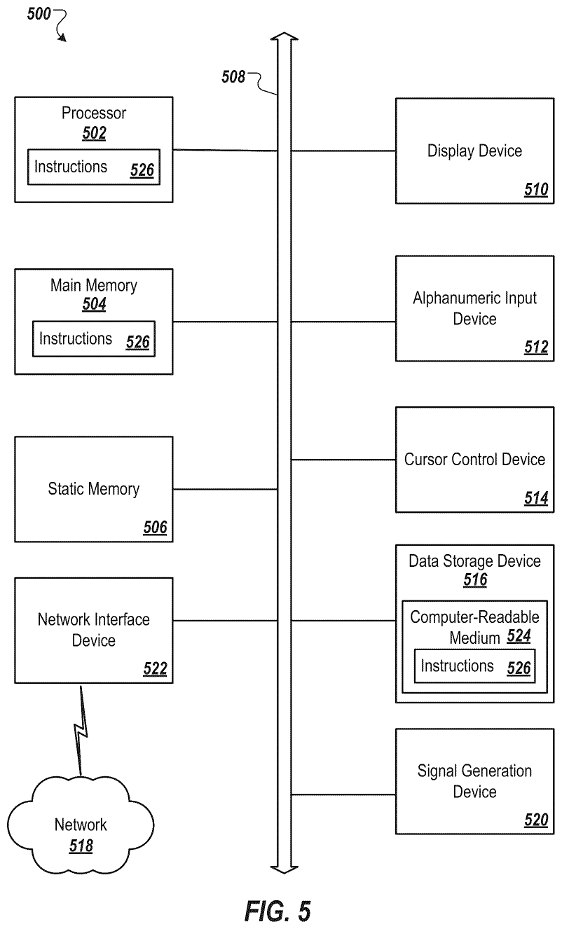

FIG. 5 illustrates an example computing device 500 within which a set of instructions, for causing the machine to perform any one or more of the methods discussed herein, may be executed. The computing device 500 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 500 includes a processing device 502 (e.g., a processor), a main memory 504 (e.g., read-only memory (ROM), flash memory, dynamic random access memory (DRAM) such as synchronous DRAM (SDRAM)), a static memory 506 (e.g., flash memory, static random access memory (SRAM)) and a data storage device 516, which communicate with each other via a bus 508.

The processing device 502 represents one or more general-purpose processing devices such as a microprocessor, central processing unit, or the like. More particularly, the processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also include one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computing device 500 may further include a network interface device 522 which may communicate with a network 518. The computing device 500 also may include a display device 510 (e.g., a liquid crystal display (LCD) or a cathode ray tube (CRT)), an alphanumeric input device 512 (e.g., a keyboard), a cursor control device 514 (e.g., a mouse) and a signal generation device 520 (e.g., a speaker). In at least one implementation, the display device 510, the alphanumeric input device 512, and the cursor control device 514 may be combined into a single component or device (e.g., an LCD touch screen).

The data storage device 516 may include a computer-readable storage medium 524 on which is stored one or more sets of instructions 526 embodying any one or more of the methods or functions described herein. The instructions 526 may also reside, completely or at least partially, within the main memory 504 and/or within the processing device 502 during execution thereof by the computing device 500, the main memory 504 and the processing device 502 also constituting computer-readable media. The instructions may further be transmitted or received over a network 518 via the network interface device 522.

While the computer-readable storage medium 524 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A system, comprising:
a user interface comprising an encryption component; and
a management system configured to generate a digital voucher in response to receiving a request from a user via the interface, wherein:
the encryption component facilitates an authentication of the user and an authorization of the user prior to submitting the request to the management system;
the digital voucher facilitates a supply chain transaction between a seller and a buyer.

2. The system of claim 1, wherein the authentication of the user confirms an identity of the user and the authorization of the user confirms the user has permissions to submit the request.

3. The system of claim 2, wherein the authentication and the authorization utilizes a public key and a private key pair.

4. The system of claim 1, wherein the digital voucher includes one or more characteristics comprising a purchase price, a redemption value, an expiration date, a future purchase discount, and a future purchase amount.

5. The system of claim 1, further comprising a distributed ledger configured to perform one or more operations relative to the digital voucher.

6. The system of claim 5, wherein the one or more operations associated with the digital voucher include generation, issuance, transfer, sale, redemption, validation, and destruction.

7. The system of claim 5, wherein the one or more operations performed by the distributed ledger are in response to a request received from the interface or the management system.

8. The system of claim 1, wherein the management system implements a marketplace for transactions relative to the digital voucher and the marketplace is configured to facilitate buying, selling, exchanging, and trading of the digital voucher.

9. The system of claim 8, wherein the digital voucher is sold to a third party in the marketplace, and the third party uses the digital voucher to redeem the future purchase from the seller.

10. The system of claim 8, wherein the digital voucher is stored in a digital wallet and the digital wallet may be used for transactions in the marketplace.

11. The system of claim 1, wherein the digital voucher represents a discount on a future purchase by the buyer from the seller according to one or more terms included in the digital voucher.

12. The system of claim 1, wherein the management system is a transaction management system.

13. The system of claim 1, wherein the management system is configured to deploy a smart contract to execute operations associated with the digital voucher.

14. The system of claim 13, wherein the smart contract is automatically deployed on a distributed ledger in response to a predefined condition being satisfied.

15. A method, comprising:
obtaining from an interface a request to generate a digital voucher, where the request is obtained from a user that is authenticated and authorized by an encryption component;
in response to authenticating and authorizing the user, deploying the digital voucher on a distributed ledger;
implementing a marketplace for transactions associated with the digital voucher, where the marketplace is configured to facilitate a sale of the digital voucher from a seller to a buyer; and
in response to a redemption of the digital voucher, destroying the digital voucher and removing the digital voucher from the distributed ledger.

16. The method of claim 15, wherein the digital voucher includes one or more characteristics comprising a purchase price, a redemption value, an expiration date, a future purchase discount, and a future purchase amount.

17. The method of claim 15, wherein the authentication of the user confirms an identity of the user and the authorization of the user confirms the user has permissions to submit the request.

18. The method of claim 15, further comprising transacting the sale of the digital voucher from the buyer to a third party in the marketplace.

19. The method of claim 15, further comprising automatically deploying a smart contract on the distributed ledger in response to a predefined condition being satisfied, where the smart contract is configured to execute operations associated with the digital voucher.

20. The method of claim 15, wherein the digital voucher is stored in a digital wallet and the digital wallet is used for transactions in the marketplace.
